(19) United States
(12) Patent Application Publication
(10) Pub. No.: US 2004/0134110 A1
(43) Pub. Date: Jul. 15, 2004

(54) Revolving around a pole multiside display assembly

(76) Inventor: Ilya Konny, Brooklyn, NY (US)

Correspondence Address: ILYA KONNY, 130 OCEANA DR. WEST, # 2A, BROOKLYN, NY, 11235, US

(21) Appl. No.: 10/342,685

(22) Filed: Jan. 13, 2003

(51) Int. Cl. G09F 15/00

(52) U.S. Cl. 40/607.03

(57) ABSTRACT

A revolving around a pole multiside (usually 4-side) with a minimum open space between the inside edge and the pole, vandal-proof display assembly for different sheets (advertising, public transportation schedules and maps and the like) is designed for mounting on a pole without removing other already mounted items.

### BACKGROUND OF THE INVENTION

The present Invention relates to displays for installation on the street poles. The most suitable for application is a round pole. With special brackets (not shown) the unit can also be installed on poles of other than round shapes and having a revolving motion.

The existing known design of such a display (U.S. Pat. No. 4,300,299) is based on the following:

a) It considers a fixed installation only.

b) It uses molded components to construct the unit.

The following are the disadvantages of the existing design:

a) Fixed installation requires a user to walk around the pole to find the necessary information sheet.

b) With molded components the unit is stocked to one and the same configuration (4-side only) with limited flexibility for modifications.

c) High tooling cost to manufacture molded components.

d) Relatively high assembly time at installation.

e) Assembled the unit has a shape of an open from top to bottom square tube which tends to collect inside of the unit the street junk (cups, food boxes, napkings, etc.).

f) The brackets attachment to poles considers of bolt-nut usage which requires 2 different tools simultaneously.

### SUMMARY OF THE INVENTION

I. A revolving around a pole multiside (usually 4-side) with a minimum open space between the inside edge and the pole, vandal-proof display assembly for different sheets (advertising, public transportation schedules and maps and the like) is designed for mounting on a pole without removing of other already mounted items.

2. The said display assembly is constructed of:

I. Aluminum Body—I (2 halves) per unit

2. Stainless steel Corner Post—4 per unit

3. Stainless steel Top Cover Inner—I per unit

4. Stainless steel Top Cover Outer—I per unit

5. Stainless steel Bottom Cover Inner—I per unit

6. Stainless steel Bottom Cover Outer—I per unit

7. .I25 thk.×6.50×23.00 coated clear polycarbonate cover sheet—4 per unit.

The display sheet is positioned inside of each of the 4 pockets between the side wall of the body (item I) and polycarbonate cover sheet (item 7). The display sheet can be easily replaced with another sheet by removing the Top Set of the Outer-Inner Covers (items 3 and 4).

### BRIEF DESCRIPTION OF THE DRAWINGS

FIG. I shows an isymmetric view of assembled 4-side unit with ability to rotate around a pole.

FIG. 2 shows the structure of the unit per Invention in details. 2 halves of aluminum profile built up a body I. Stainless steel formed Inner 5 and Outer 6 Bottom Covers with drain holes are screwed to the body by (4) selftapping flat head tempered Stainless steel Screws using extruded screw slots of the body I. (4) Stainless steel formed Corner Posts 2 slide over extruded shapes of the body I and rest inside of the Bottom Covers 5 and 6. (4) coated clear polycarbonate cover sheets 7 slide inside of each of the side pockets and rest inside of items 5 and 6. Displayed Information Sheets are positioned between the body I side wall and the polycarbonate cover sheet 7.

Stainless steel formed Inner 3 and Outer 4 Top Covers similar to items 5 and 6 but without drain holes are screwed to the body I in the same manner as items 5 and 6.

FIGS. 3 and 4 show assembled body I and the way it is put together.

FIG. 5 shows the aluminum profile of the extrusion per Invention used for each half of the body I.

The aluminum profile is of a “U”-shape with (2) screw slots (0.228 ID/0.328 OD), (2) of 0.97I/0.490×0.075 wall extruded angles to carry Stainless steel Corner Posts 2. The open edges of the “U”-shape have an extruded I.I05 on one edge and .I40 R on another edge hinge joint in such a manner that (2) halves of this extruded shape can slide one edge over another edge to construct an open rechtangular tube of 7.692×6.750 inches in sides. As an option the body I can also be manufactured from stainless steel as shown on FIG. 6. (3) formed side panels and formed body top and body bottom plates with a set of holes to mount the brackets are spotwelded to form a body from one side open box. The formed body top and body bottom plates have an opening for pole installation.

(I) formed stainless steel side panel remain loose so the body can be installed on a pole without removing of other already mounted on the pole items.

FIGS. 7 and 8 show the bracket installation on a round pole.

(2) pole-mounted brackets are screwed around the pole to create a disc of .I25″ thk and 2.25″ R.

A body bracket is screwed to one half of the body using prepunched mounting holes and (2) of I0-32 flat head stainless steel screws, so the screw heads are even with the side wall of the body surface. The body bracket has a slot in center to carry the sliding brackets. (2) sliding brackets are installed with one end into the body bracket slot over the sliding edge of the pole-mounted bracket. Hard greese is to be applied on the contact surface between the pole-mounted and sliding brackets for smooth motion. The second end of the sliding brackets is screwed one to another while a spacer eliminates any misplacement of the sliding brackets.

FIG. 9 shows the Pole-mounted brackets -I(male) and -2(female). The aluminum version of the Pole-mounted brackets can be molded, while the stainless steel version—welded. The -I bracket—an incomplete semidisc of .I25″ thk, 2.25″ outside and I.5″ inside radii, .I25″ shorter at each end than a full semidisc. The inside radius may vary with the pole diameter. (2) flanges of .I25″ thk, 0.50″×0.50″ with a 0.203″ hole in center is located on each side of the semi-disc on top and bottom. A 0.062×0.375″ long guiding pin at each end eliminates any vertical misplacement. The -2 bracket is basically similar to the -I bracket, except the (4) flanges have a I0-32 tapped hole. As an option, I0-32 threaded inserts may be used instead of tapped holes. Each end of the -2 bracket has a 0.065″ hole to accept the guiding pins, so the -I and -2 Pole-mounted brackets can be lined up at installation. The edge of the semidiscs is bullnosed with a full 0.062″ R.

FIG. I0 shows the Sliding brackets -I and -2. The Sliding brackets are formed from I6 gauge stainless steel to create a .I56″×0.25″ channel with 2.25″ R so it can slide over the corresponding edge of the Pole-mounted brackets. One end of the Sliding brackets is bent so it can be installed into the slot of the body-bracket. The 2-nd end of the Sliding brackets is bent so the (2) flanges of -I and -2 brackets are parallel while installed. The -I Sliding bracket has a 0.203″ hole and the -2 Sliding bracket has a drawn and threaded I0-32 hole so while installed these holes are in line. Each bent end has slots in center so the Pole-mounted bracket disc can rotate thru without interfearance.

The body bracket (FIG. 8) is made from .I25″ thk stainless steel with mounting I0-32 threaded holes at ends and a slot in the middle to carry the Sliding bracket ends. The body bracket is formed so the brackets set can be positioned exactly in center of the body. (2) sets of the body brackets, Pole-mounted brackets and the Sliding brackets is required for one display assembly.

FIG. II shows an isymmetric view of a revolving set of brackets applicable in case of the stainless steel version of the body (FIG. 6) with modified body top/bottom plates having an opening with 2.25″ R.

FIG. I2 shows the top/bottom brackets and the bridge. The top/bottom brackets are made from stainless steel size 4, schedule I0 pipe and consists of (2) halves with clamping .I25″ thk stainless steel flanges and a bent 0.25 rod welded to the outside surface of the brackets. The top brackets in addition have stops welded to the outside surface of the brackets. The bridge is fabricated from I3 gauge stainless steel and mounted around the assembled brackets to the body top/bottom plate in such a way that the bridge and the round edge of the body top/bottom plate opening slides around the outside surface of the bracket assembly between the rod and the stops.

FIG. I3 and I4 show the Inner and Outer covers for a 03″ pole. The covers are made from 20 gauge polished stainless steel. The Inner cover has 3 formed edges, (4) 0.56 holes and a cutout in center with 2″ R. In addition the Inner bottom cover has a set of drain holes. The Outer cover has 3 formed edges, formed countersunk (4) holes and a cutout in center with 2″ R. In addition, the Outer bottom cover has a set of drain holes. The covers are formed in such a way so they can fit the Outer over the Inner creating a 4-side cover plate with a 0.50″ clearance space between the cutout and the pole.

FIG. I5 shows a corner post. The corner post is formed from I8 gauge polished stainless steel in such a way so it can slide over the extruded elements of the body and fit inside of the top/bottom cover sets. The 0.25″ lips bent at 45° are holding the polycarbonate sheets in place.

The revolving motion of the proposed design can also be applied to other than round pole styles of poles, such as square and “U”-shape. It will require different special styles of revolving brackets (not shown).

In addition to revolving application the proposed design can also be used for fixed mounting. FIG. I6 shows mounting brackets for a 03″ pole. FIGS. I7 and I8 show brackets to mount the proposed unit on a “U”-shape pole parallel and at 45° with respect to the curb.

FIG. I9 shows brackets to mount the unit on a 3″ square pole.

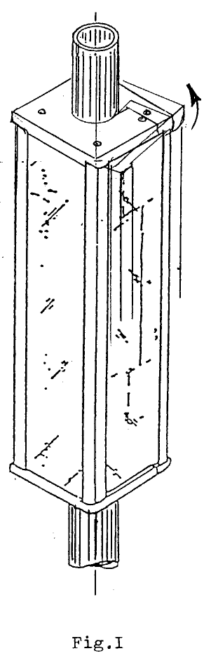

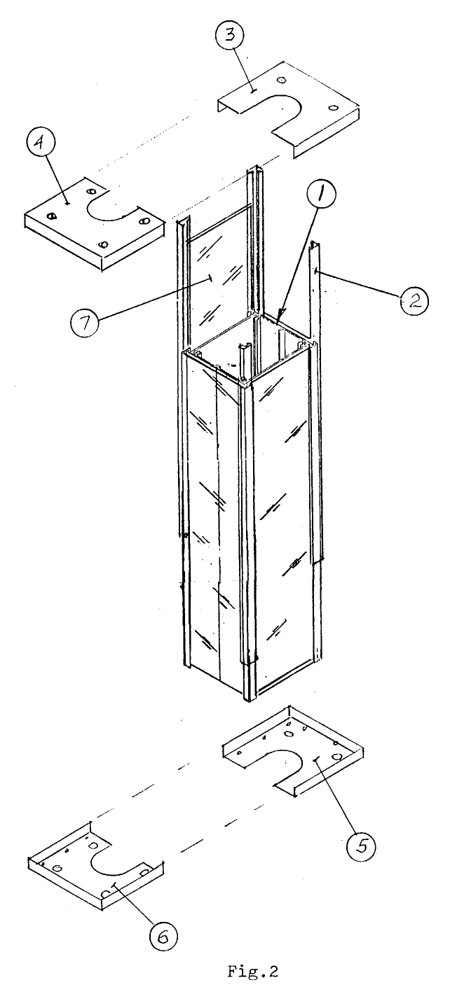

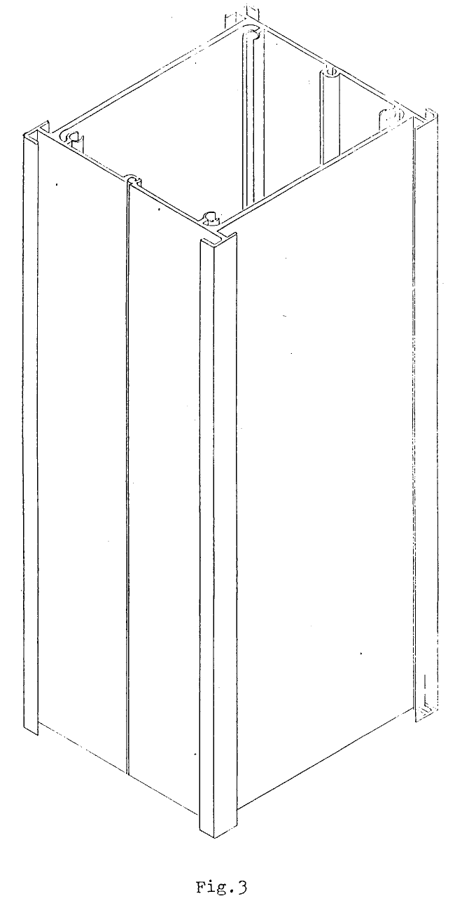

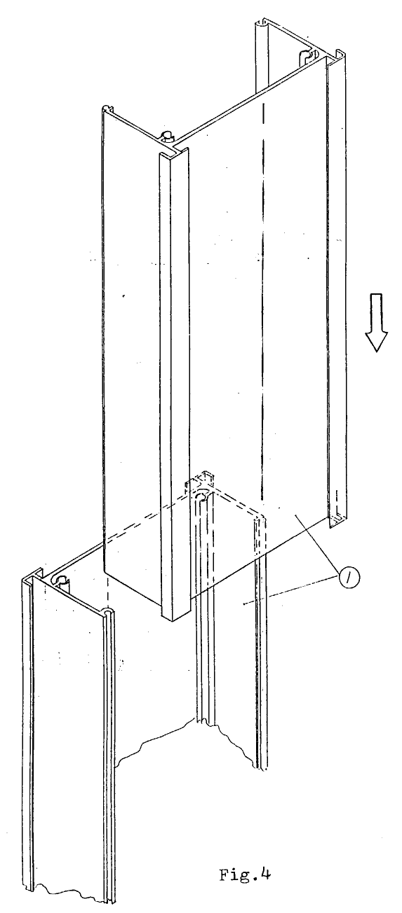

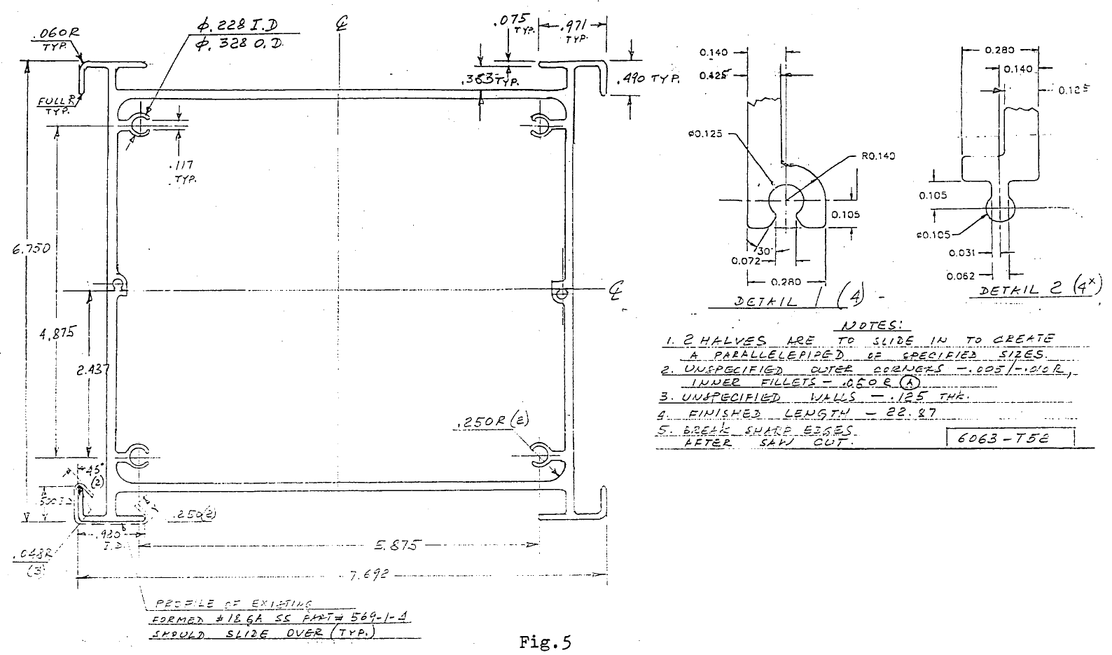

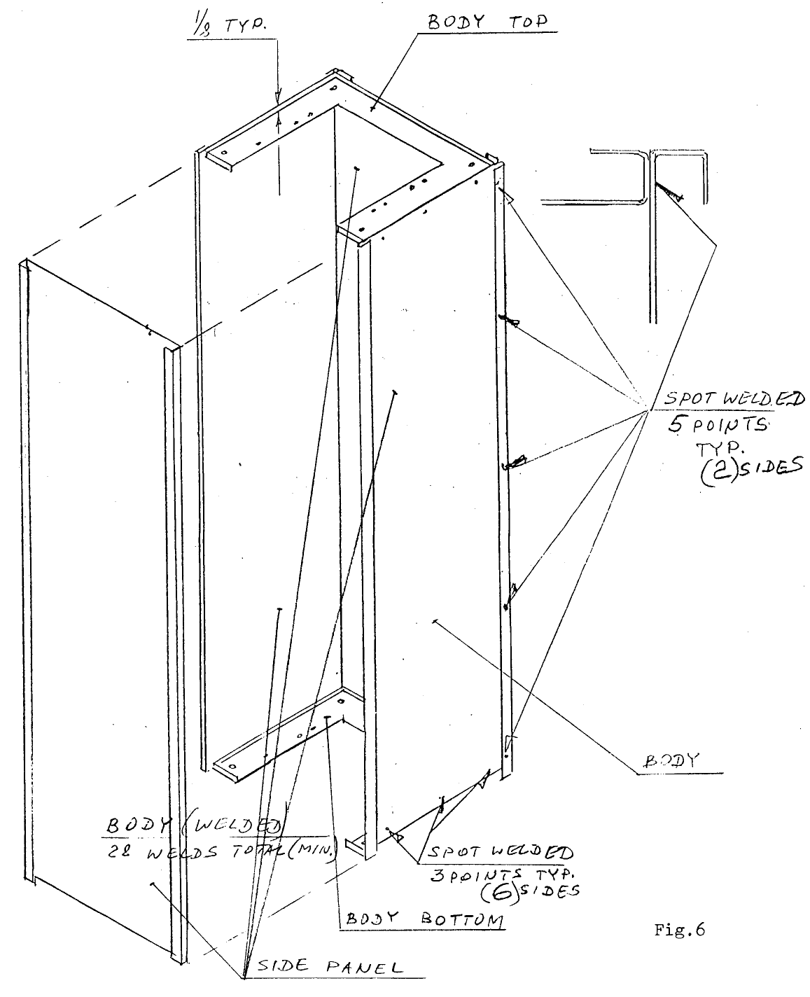

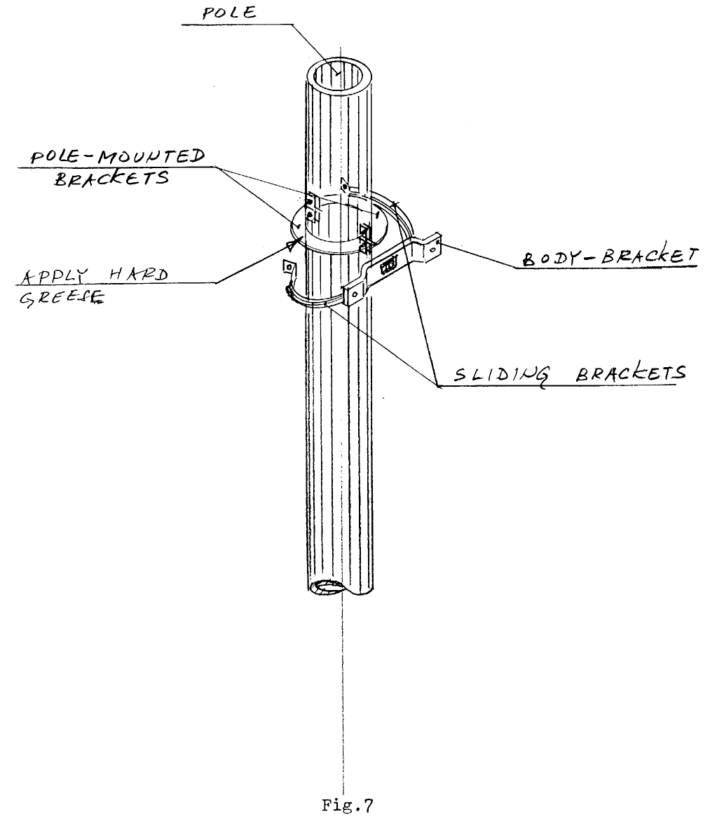

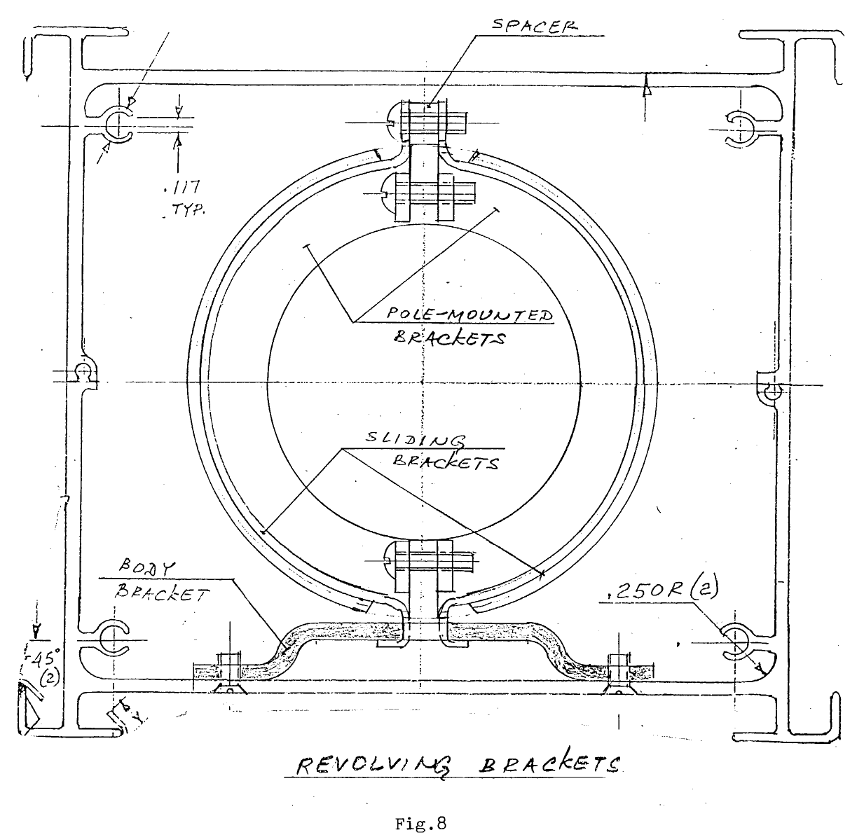

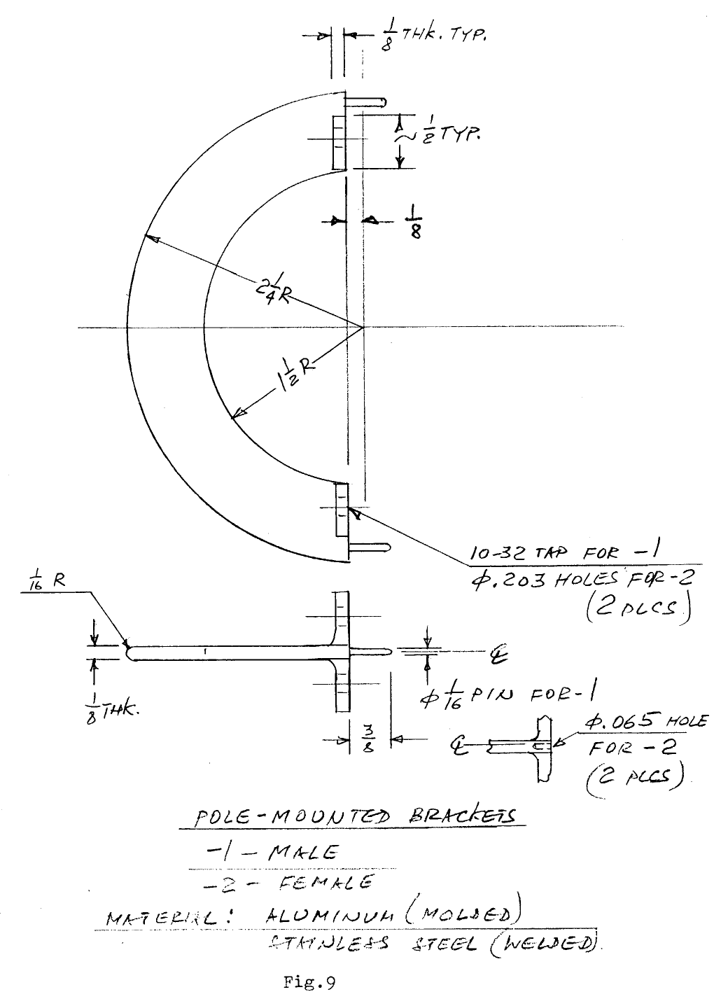

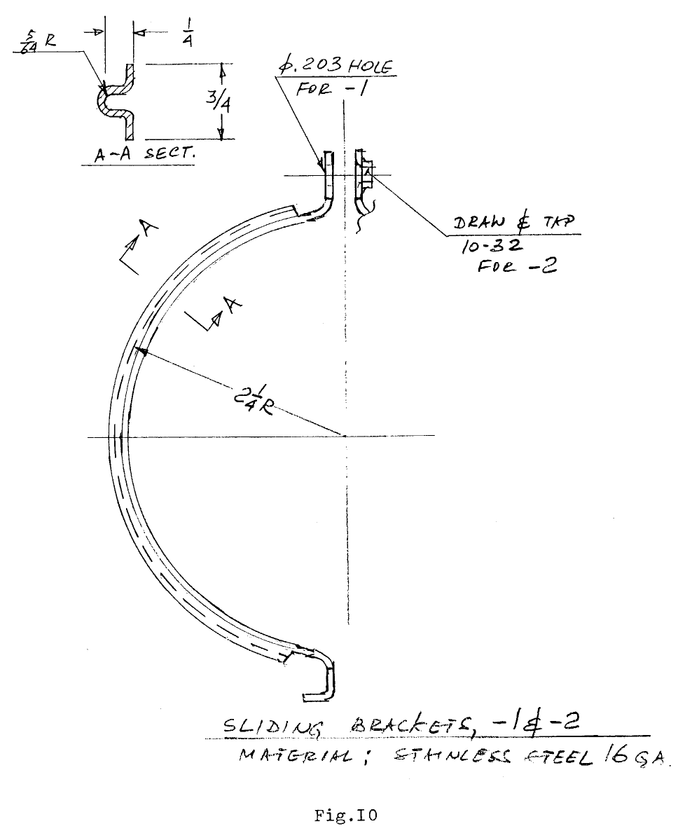

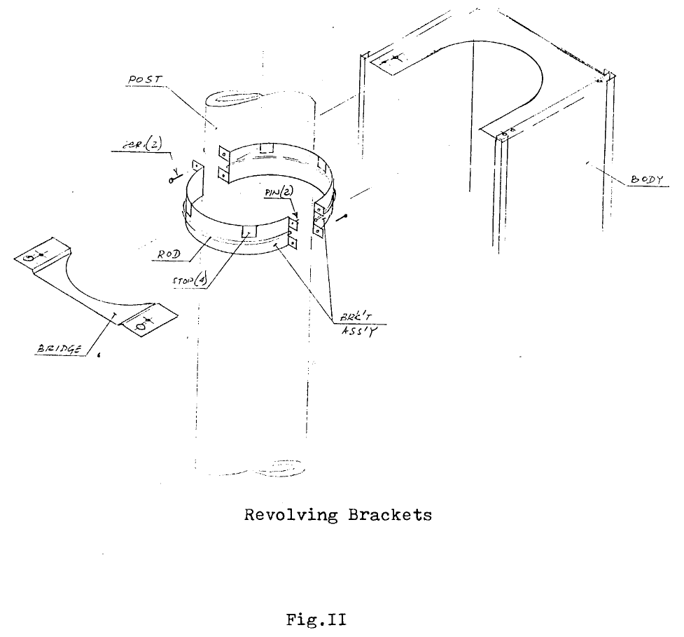

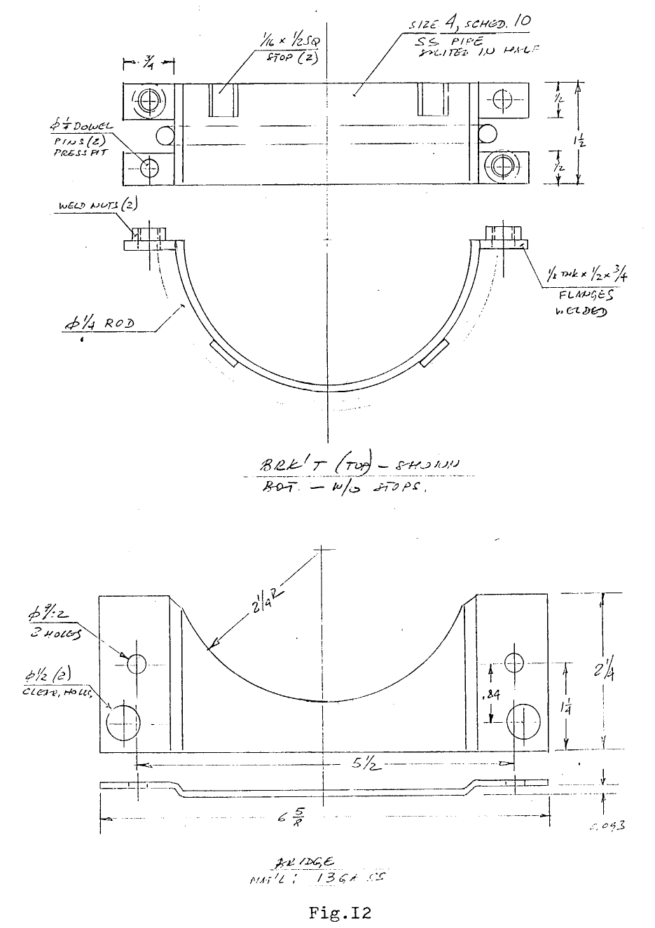

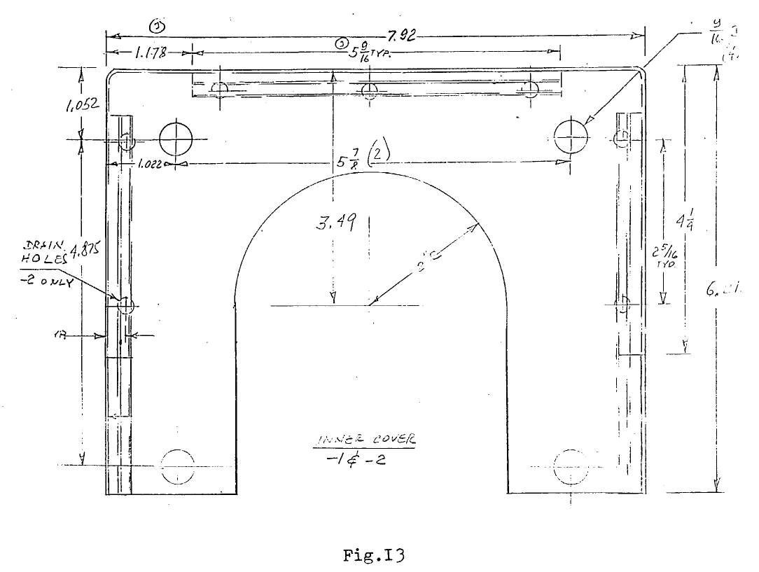

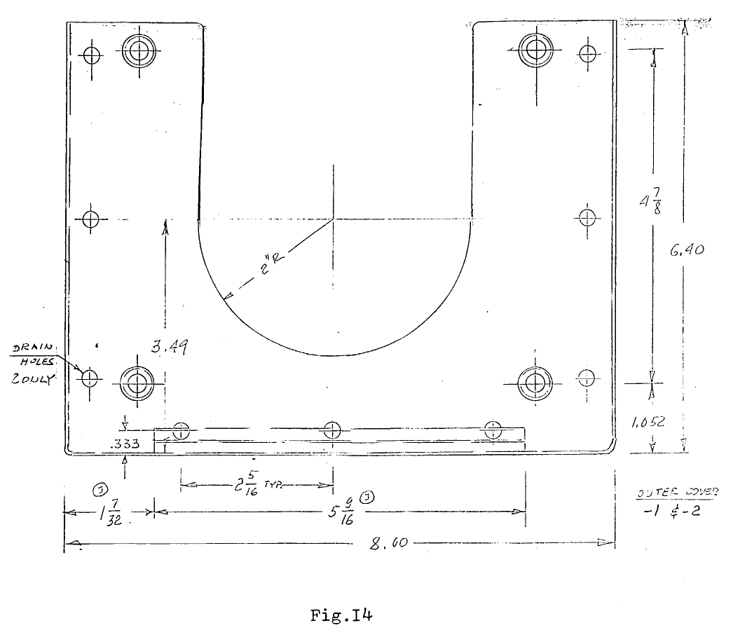

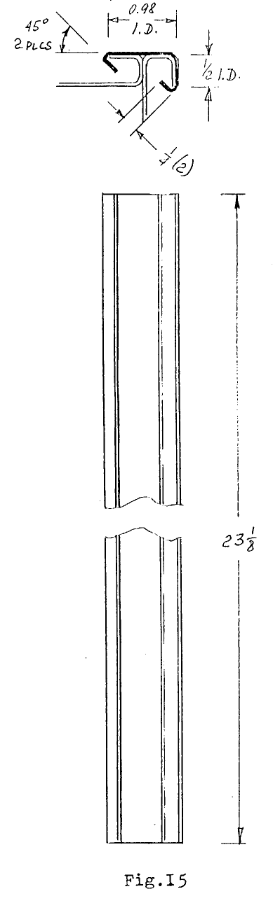

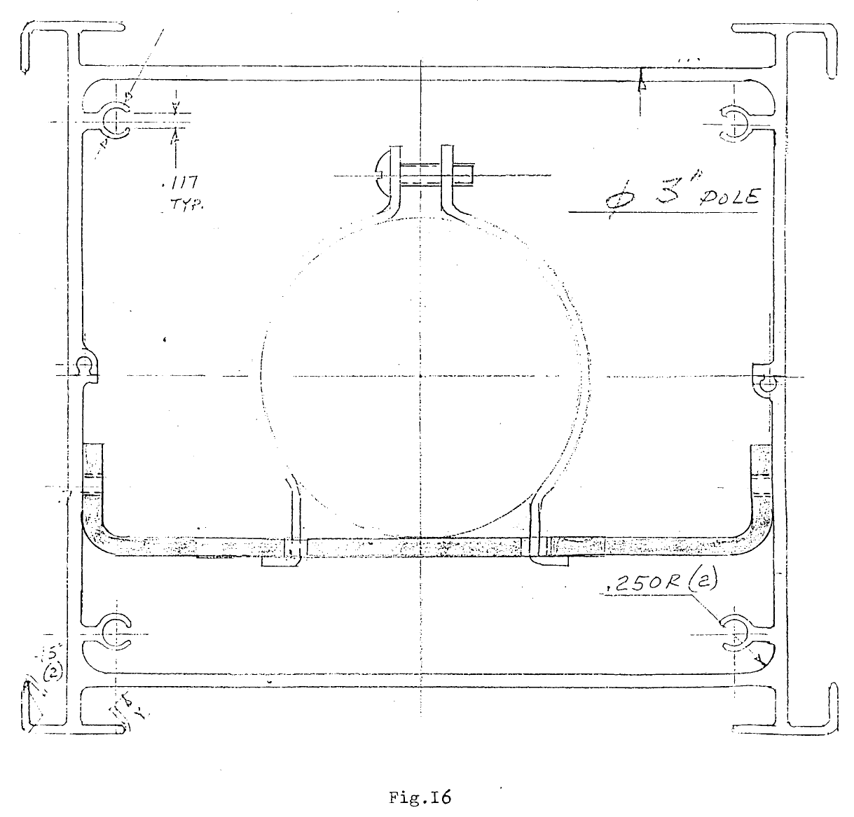

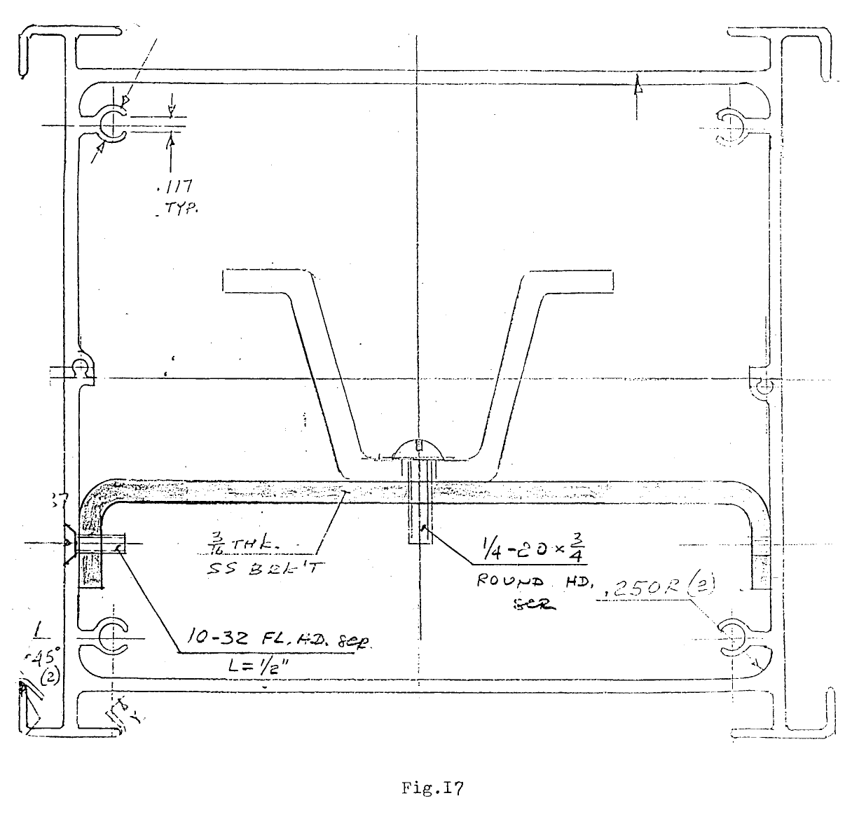

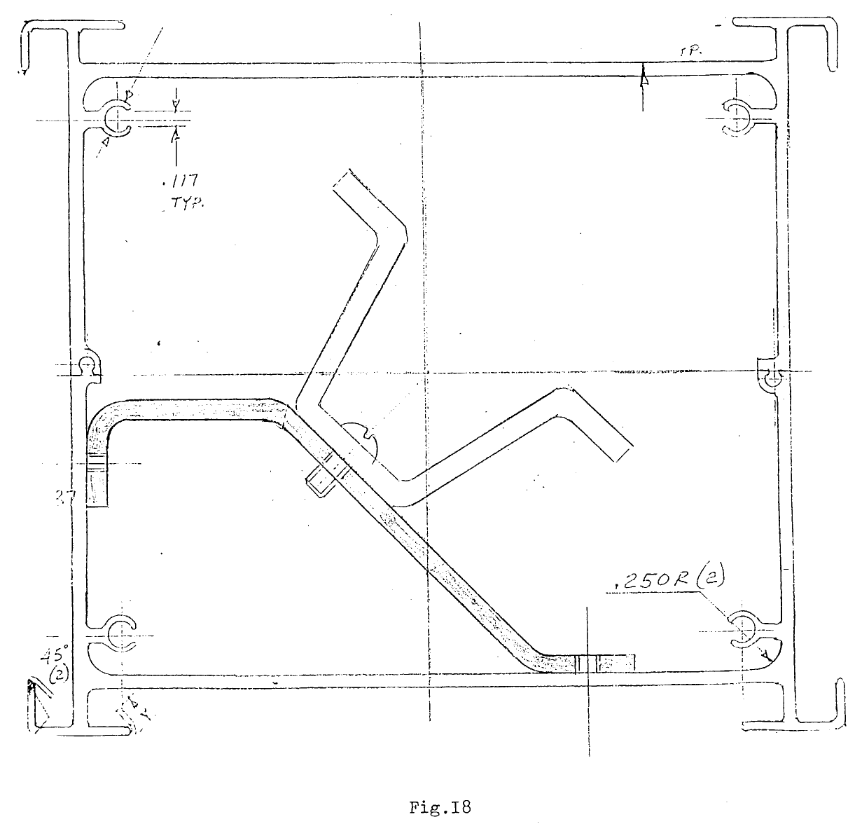

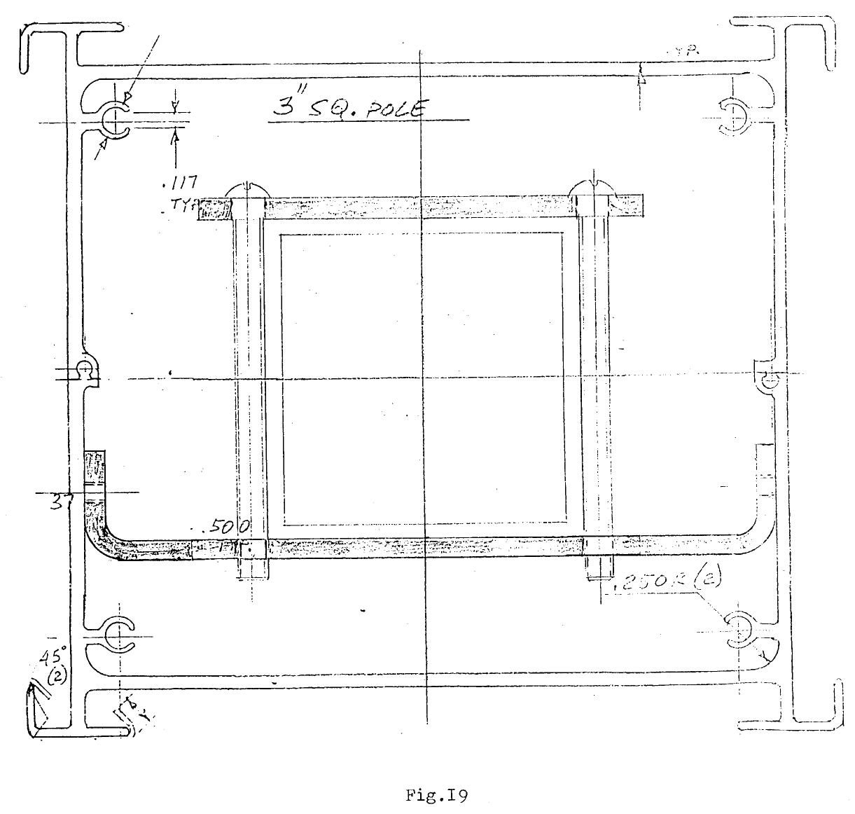

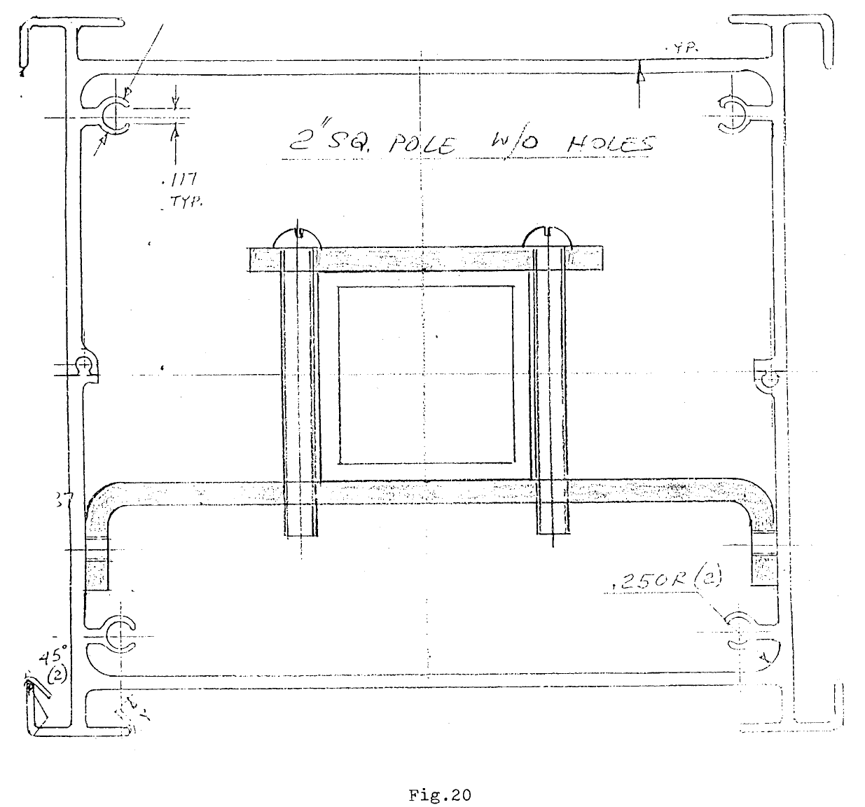

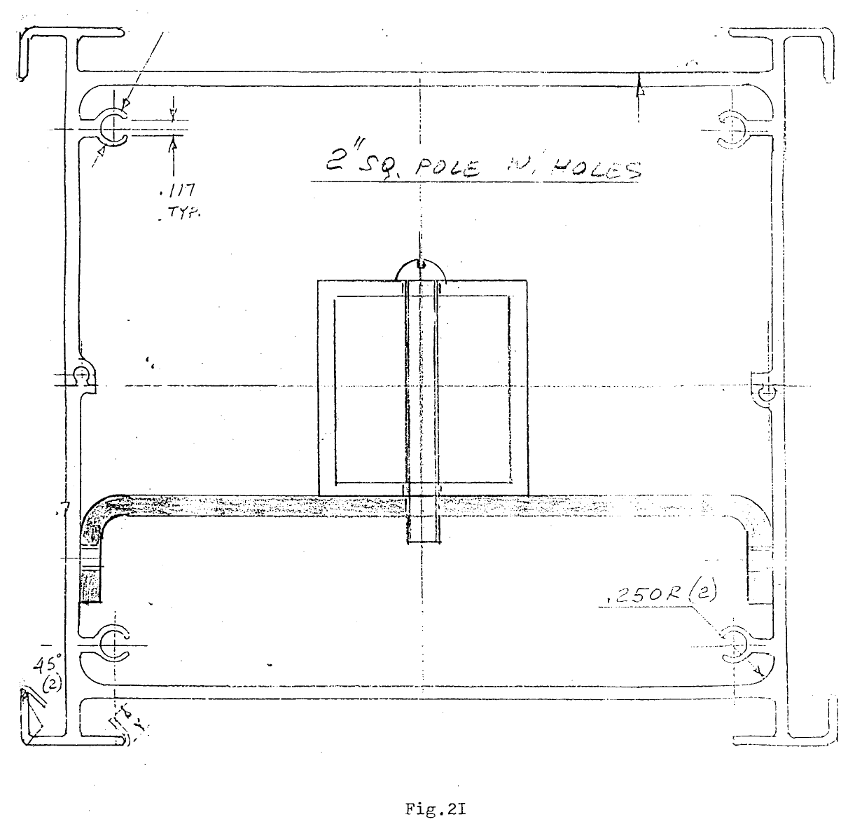

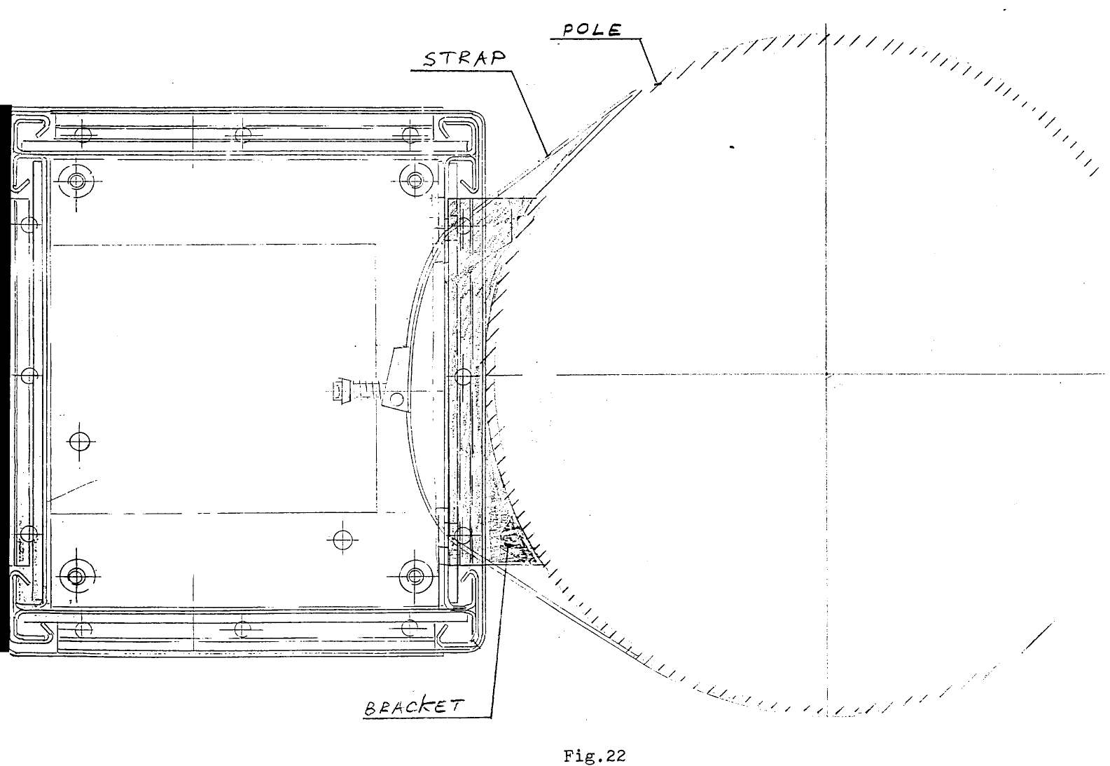

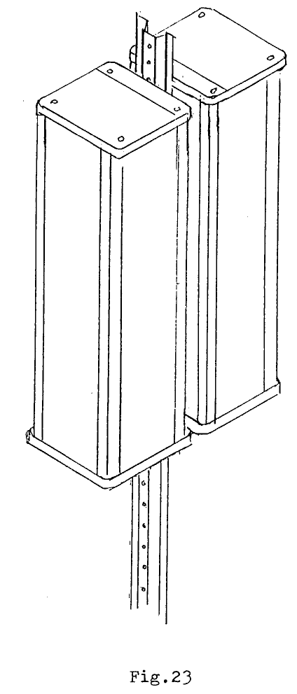

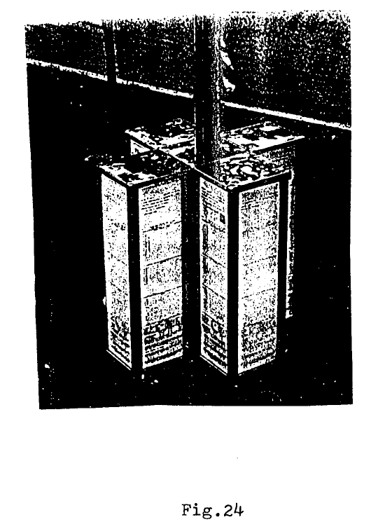

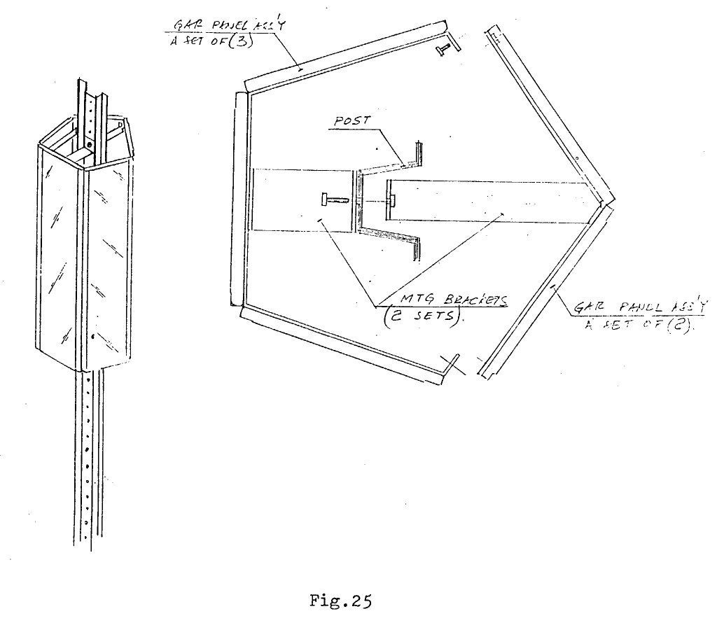

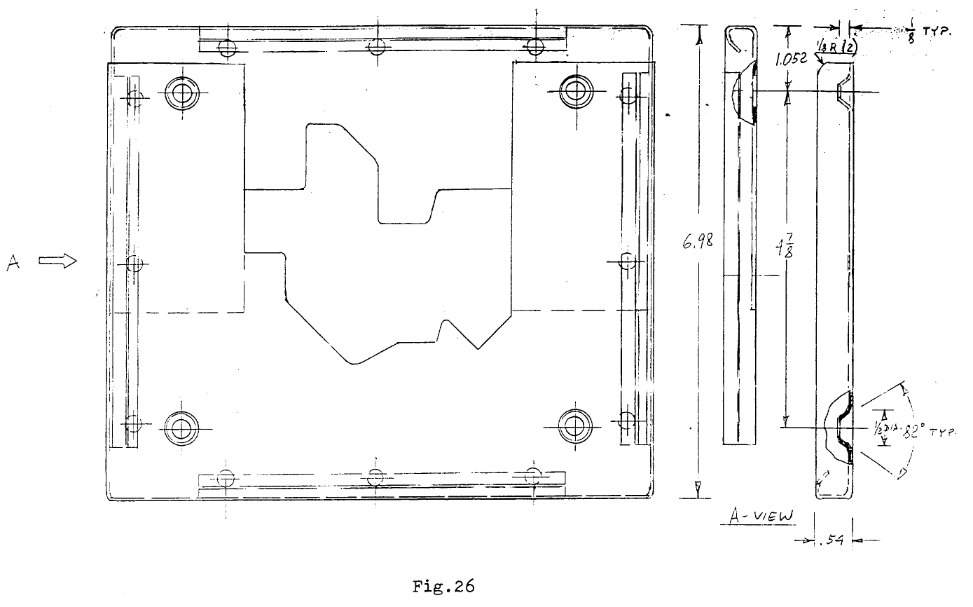

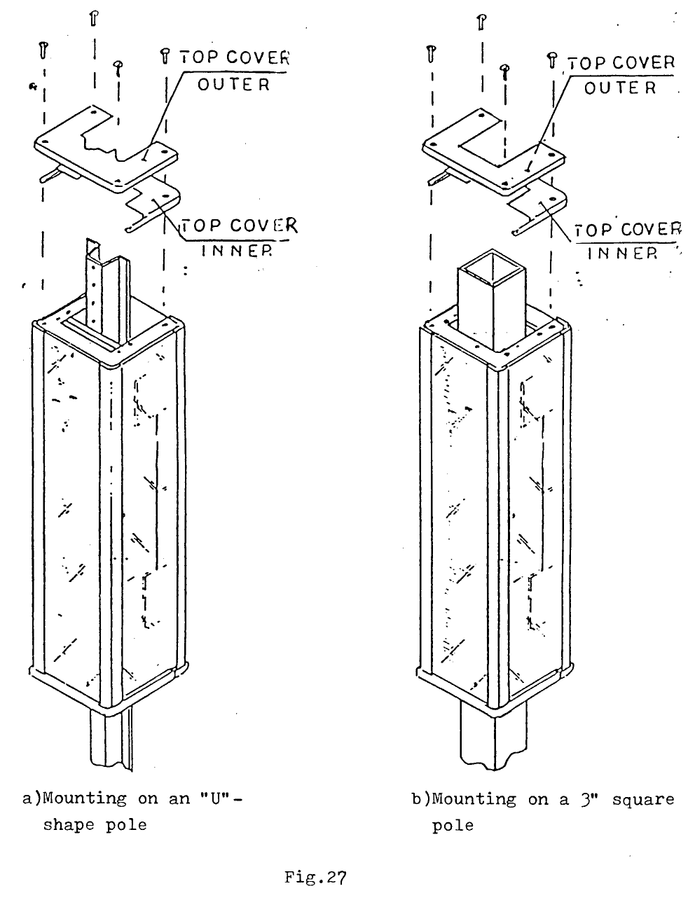

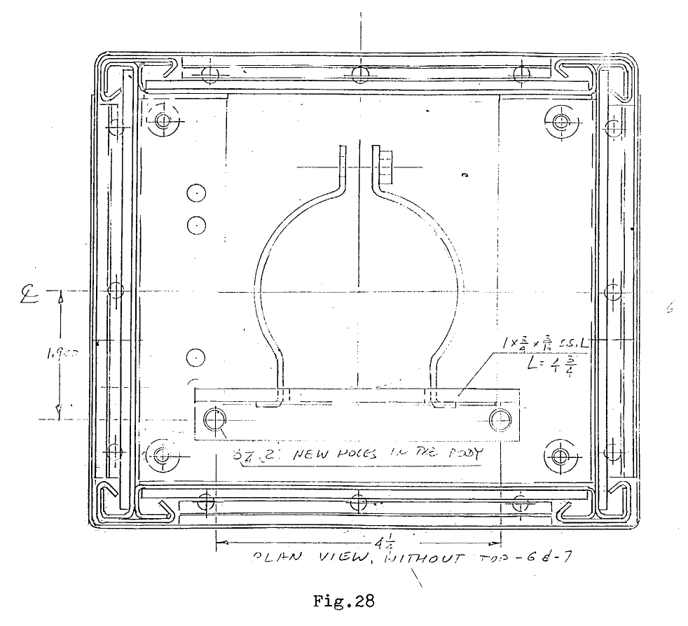

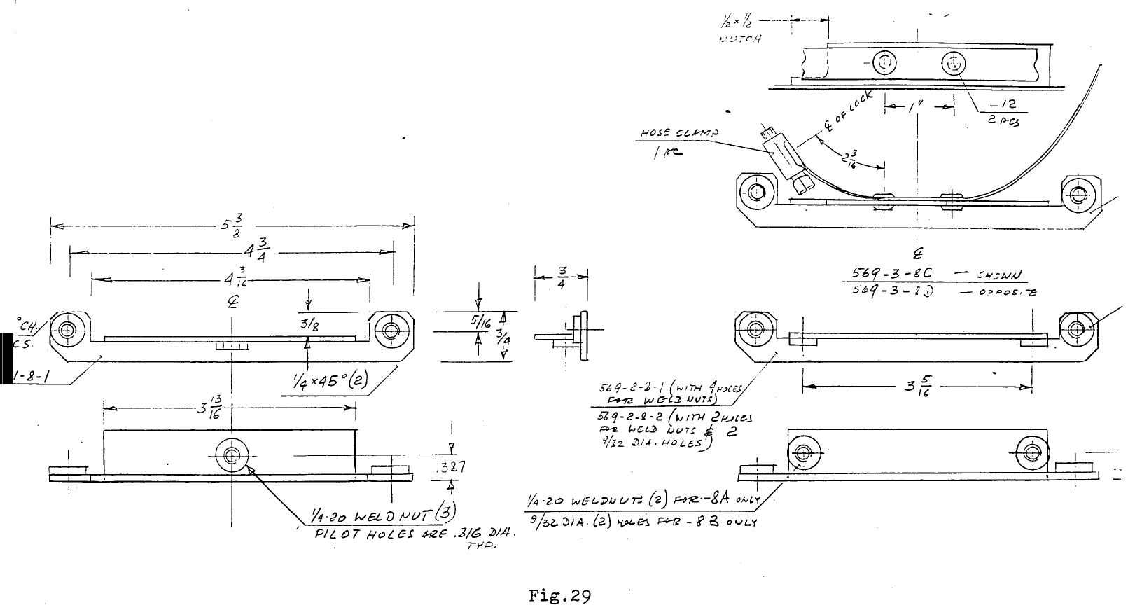

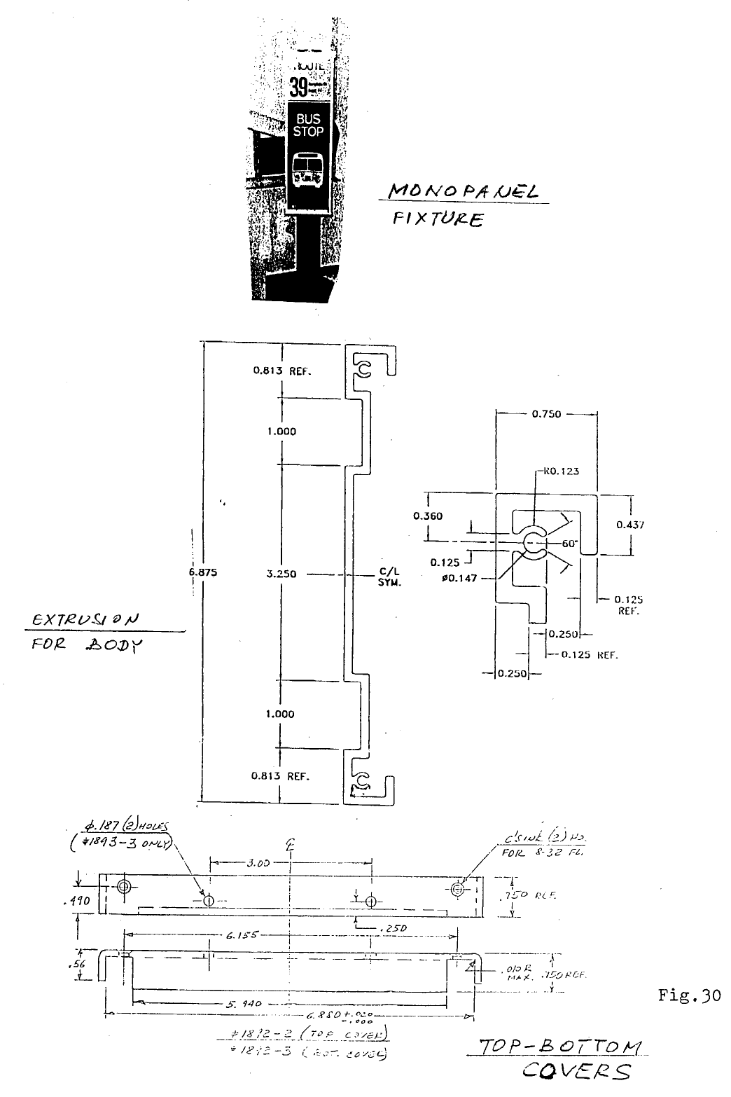

FIG. 20 and 2I show mounting brackets for a 2″ square pole without and with hole correspondingly.

FIG. 22 shows the mounting brackets for a round pole of a large diameter. In this case the display unit is mounted outside of the pole using a stainless steel strap. The unit has 3 sides available for sheet installation.

FIG. 23 and 24 show different group-mounting combinations, back-to-back units and a bondle of 4 units correspondingly.

FIG. 25 shows a possible pentagonal display unit. Corresponding top/bottom inner and outer covers assembled have also a pentagonal shape (not shown).

FIG. 26 shows an assembled stage of the top/bottom covers for a fixed mounting on a “U”-shape pole. The covers have a special profile of the cutout to accept a parralel and at 45° with respect to the curb mounting with a minimum space between the inner edge and the pole.

FIG. 27 shows an isymmetric view of

a) mounting on a “U”-shape pole

b) mounting on a 3″ square pole. The top/bottom covers have a 4″ square opening with a 0.50″ space between the inner edge and the pole.

FIG. 28 shows a set of brackets for a fixed mounting on a round pole using the stainless steel version of the body (FIG. 6).

FIG. 29 shows different styles of mounting brackets in conduction with the stainless steel version of the body (FIG. 6).

A particular case of a fixed-mounting display unit is a monopanel shown on FIG. 30 (a revolving monopanel does not make sence). The body is made from an aluminum extrusion with (2) screw slots to attach the top/bottom covers. The extruded profile accepts installation of a .I25″ thk clear coated polycarbonate cover and the sheet to be displaced positioned between the polycarbonate cover and the body. There is an extruded recess in the center of the shape to accept a hidden nut for back-to-back mounting of (2) monopanels. (2) mounting holes (not shown) are to be prepunched along the cen- line, spaced to match the holes in the pole. The top/bottom covers are fabricated from the standard aluminum “L”-shape profile with 2 countersunk holes for a flat head screw. The covered are formed in such a way that to overlap the extruded body with a minimum clerance. The bottom cover has drain holes. The body and the covers may be anodized clear, black, colored.

It is to be understood that this Invention is not to be limited by the components chosen herein to represent it and the claims are intended to cover all changes and modifications.

The following is claimed

1. A Revolving around a pole multiside display assembly.

2. A display assembly of claim I consisting of
a) Body
b) Top/Bottom Inner and Outer covers.
c) Corner posts.
d) Clear coated polycarbonate cover sheets.
e) Bracket set for revolving and fixed installation.
f) A Monopanel as a particular case of a multiside unit.

3. A body consisting of (2) halves of claim 2.

4. An aluminum extrusion profile of claim 3.

5. A stainless steel version of the body of claim 2.

6. A stainless steel Top/Bottom Inner covers for a 03″ pole, “U”-shape pole and 3″ square pole with a minimum space between the inner edge and the pole of claim 2.

7. A stainless steel Top/Bottom Outer covers for a 03″ pole, “U”-shape pole and 3″ square pole with a minimum space between the inner edge and the pole of claim 2.

8. Stainless steel Corner Posts of claim 2.

9. A set of revolving brackets for an aluminum extruded version of the body of, claim 2.

10. A set of revolving brackets for a stainless steel version of the body of claim 2.

11. A set of brackets-for fixed mounting of the aluminum extruded body on an “U”-shape pole parallel and at 45° with respect to the curb, on a round pole, on a 2″ square pole with and without holes, on a 3″ square pole, on a round pole of a large diameter of claim 2.

12. A set of brackets for fixed installation of a stainless steel version of the body on an “U”-shape pole parallel and at 45° with respect to the curb, on a round pole, on a 2″ square pole with and without holes, on a 3″ square pole, on a round pole of a large diameter of claim 2.

13. A pentagonal version of claim I.

14. A group-mounting method of claim I.

15. A Monopanel as a particular case of claim I.

16. An aluminum extrusion profile of claim I5.

17. Top/Bottom covers of claim I5.
